(19) United States
(12) Patent Application Publication
(10) Pub. No.: US 2025/0103849 A1
(43) Pub. Date: Mar. 27, 2025

(54) HIGH-DIMENSIONAL COMPUTING BASED TRAINING AND INFERENCING

(71) Applicant: International Business Machines Corporation, Armonk, NY (US)

(72) Inventors: Michael Andreas Hersche, Zurich (CH); Kumudu Geethan Karunaratne, Adliswil (CH); Abu Sebastian, Adliswil (CH); Abbas Rahimi, Rüschlikon (CH)

(73) Assignee: International Business Machines Corporation, Armonk, NY (US)

(21) Appl. No.: 18/371,147

(22) Filed: Sep. 21, 2023

(51) Int. Cl. G06N 3/04; G06N 5/04

(52) U.S. Cl. CPC G06N 3/04; G06N 5/04

(57) ABSTRACT

An embodiment establishes a neural network that comprises a plurality of layers. The embodiment receives a plurality of input data sequences into a layer of the neural network, the plurality of input data sequences comprises a first input data sequence and a second input data sequence. The embodiment superposes the first input data sequence and the second input data sequence, thereby creating a superposed embedding. The embodiment transforms the superposed embedding by applying a function to the superposed embedding, thereby creating a transformed superposed embedding. The embodiment infers a first output data element corresponding to the first input data sequence and a second output data element corresponding to the second input data sequence via application of an unbinding operation on the transformed superposed embedding.

### BACKGROUND

The present invention relates generally to high-dimensional computing. More particularly, the present invention relates to a method, system, and computer program for multiple-input-multiple-output high-dimensional computing (HDC) based training and inferencing.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A transformer network is a type of deep learning neural network architecture that includes a parallel multi-head attention mechanism. A core innovation of the transformer network includes the self-attention mechanism, which allows the model to weigh the importance of different elements in a sequence when processing each element. This mechanism enables the model to capture long-range dependencies in data efficiently. Further, the self-attention mechanism in a transformer network is often used with multiple attention heads, which enables the model to focus on different parts of the input sequence simultaneously, thus enabling the model to capture different types of patterns and relationships. Further, the transformer architecture is highly parallelizable, making it computationally efficient. Further, unlike a recurrent neural networks (RNN) or a convolutional neural networks (CNN), which process elements sequentially, the transformer network may process all elements in a sequence simultaneously.

High-dimensional computing (HDC) is a brain-inspired non von Neumann computing paradigm based on representing information with high-dimensional (e.g., 10,000 dimensions) but fixed vectors. HDC includes three main operations—superposition, binding, and permutation—that form an algebra over the space of high-dimensional vectors. The application of these well-defined operations on the vector space allows data structures to be transformed holistically—i.e., without decomposition.

### SUMMARY

The illustrative embodiments provide for high-dimensional computing based training and inferencing. An embodiment includes establishing a neural network that comprises a plurality of layers. The embodiment also includes receiving a plurality of input data sequences into a layer of the neural network, the plurality of input data sequences comprises a first input data sequence and a second input data sequence. The embodiment also includes superposing the first input data sequence and the second input data sequence, thereby creating a superposed embedding. The embodiment also includes transforming the superposed embedding by applying a function to the superposed embedding, thereby creating a transformed superposed embedding. The embodiment also includes inferring a first output data element corresponding to the first input data sequence and a second output data element corresponding to the second input data sequence via application of an unbinding operation on the transformed superposed embedding. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example MIMONet module in accordance with an illustrative embodiment;

FIG. 4 depicts a block diagram of an example MIMONet module in accordance with an illustrative embodiment;

FIG. 5 depicts a depicts a block diagram of an example process for high dimensional computing based neural network training and inferencing in accordance with an illustrative embodiment;

FIG. 6 depicts a block diagram of an example a neural network model architecture in accordance with an illustrative embodiment;

FIG. 7A depicts an example formula related to aspects of a process for high dimensional computing based neural network training and inferencing in accordance with an illustrative embodiment;

FIG. 7B depicts example formulae related to aspects of a process for high dimensional computing based neural network training and inferencing in accordance with an illustrative embodiment;

FIG. 7C depicts an example formulae related to aspects of a process for high dimensional computing based neural network training and inferencing in accordance with an illustrative embodiment;

FIG. 7D depicts an example formula related to aspects of a process for high dimensional computing based neural network training and inferencing in accordance with an illustrative embodiment

FIG. 8 depicts flowchart illustrating an example process for high dimensional computing based neural network training and inferencing in accordance with an illustrative embodiment;

FIG. 9 depicts a flowchart illustrating an example process for high dimensional computing based neural network training and inferencing in accordance with an illustrative embodiment;

### DETAILED DESCRIPTION

Attention has been used in many works prior to transformer networks, most notably for Natural Language Processing (NLP) combined with Recurrent Neural Networks (RNNs). In recent years, the “Transformer” architecture was introduced, which relies solely on attention and fully connected layers, demonstrating great performance in a variety of tasks. However, the computation cost and memory requirements for computing attention grow quadratically according to the sequence length, which poses a number of challenges, including the Transformer architecture's applicability to smart agents, as well as for other applications.

As mentioned, a deficiency of the attention module includes the traditionally non-linear computation of the attention module. Accordingly, naive computation of the attention module involves quadratic complexity, thus requiring a substantial amount of compute resources and memory to train and inference a model. Further, due the quadratic complexity involved with traditional attention modules, long sequences of data may be especially computationally expensive, thus hindering and/or preventing the ability for scaling models with traditional attention modules.

It is contemplated herein that the significant computational costs associated with existing models may present a variety of problems and/or undesirable consequences. For example, high computational demands may place a heavy burden on existing hardware infrastructure, thereby impacting the overall stability of the system. Accordingly, the strain placed on hardware infrastructure may cause overheating issues, leading to unexpected crashes or errors in system operation and data processing. Increased strain on the hardware infrastructure may cause permanent damage to the hardware, or otherwise may require the system to slow processing and reduce computational speed to mitigate and/or prevent causing damage. Additionally, increased computation demand causes increased energy consumption, thereby causing a number of environmental concerns, including carbon dioxide emissions resultant from burning fossil fuels to provide energy. Furthermore, the significant computational expenses associated with increased computational demand caused by existing models may cause some existing models to be unusable by organizations or systems with limited computational resources.

Despite improvements in artificial neural network technology, there is currently no architecture, system, method, etc., that includes superposing a plurality of inputs and performing computations in superposition for a non-linear multilayer function. Embodiments disclosed herein address the above noted deficiencies, including deficiencies associated with training and/or inferencing a transformer network, at least by providing an HDC-based computation-in-superposition approach configured to simultaneously pass multiple samples through attention modules in a single pass. This approach may be achieved by superposing multiple keys, values, and queries, that all may be protected by projecting keys, values, and queries into individual subspaces, thereby binding them with a unique, randomly drawn ID vector. The compressed representation achieved via binding elements reduces computational complexity in training and inference of a transformer network.

The illustrative embodiments provide for high-dimensional computing based neural network training and inferencing. Embodiments disclosed herein describe the neural network as a transformer network; however, use of this example is not intended to be limiting, but is instead used for descriptive purposes only. Instead, the network can include elements of one or more of a transformer network, a performer network, an encoder-only transformer network, a decoder-only transformer network, as well as any other variant of a transformer network, and any other type of neural network architecture currently existing or to be developed.

As used throughout the present disclosure, the term “high-dimensional computing” (or simply “HDC”) refers to a computing paradigm based on representing information with high-dimensional vectors (e.g., thousands of elements). HDC includes the utilization of various operations, including but not limited to, superposition, binding, and permutation. The term “superposition” refers to a process that combines two vectors together to create a new representation that represents the original vectors in a single new vector. The term “binding” refers to the process of combining different features together to create a representation that encodes all the features at the same time. As used throughout the present disclosure, the term “computing in superposition” refers to performing one or more operations, transformations, calculations, etc., on a superposed vector. Accordingly, computing in superposition includes the performance of a single computation on a superposed input that originates from two or more different non-interfering subspaces, wherein the single computation is reflected on the inputs of both non-interfering subspaces. Computing in superposition involves performing computations in non-interfering orthogonal projected spaces, such that the non-interfering subspaces enable the performance of operations without interference with one another.

As used throughout the present disclosure, the term “vector” refers to a data structure stored on a non-transitory medium that includes an ordered collection of values representing information or features. The dimension of a vector corresponds to the number of elements the vector contains, and each dimension refers to a specific attribute, feature, or value associated with the vector. The values represented by the vector may be manipulated and/or combined in different ways as a means to analyze the relationships between different vectors.

As used throughout the present disclosure, the term “transformer network” (or simply “Transformer”) refers to a neural network architecture that includes a parallel multi-head attention mechanism. An aspect of the transformer network includes the self-attention mechanism, which allows the model to weigh the importance of different elements in a sequence when processing each element. The self-attention mechanism enables the model to capture long-range dependencies in data efficiently. Further, the self-attention mechanism in a transformer network is often used with multiple attention heads, which enables the model to focus on different parts of the input sequence simultaneously, thus enabling the model to capture different types of patterns and relationships. Further, the transformer architecture is highly parallelizable, enabling the model to be computationally efficient. Further, in contrast to a recurrent neural network (RNN) or a convolutional neural network (RNN) which process elements sequentially, the transformer network may process all elements in a sequence simultaneously. Transformers are typically composed of an encoder stack and a decoder stack for sequence-to-sequence tasks. The encoder stack processes the input sequence, and the decoder stack generates the output sequence.

As used throughout the present disclosure, the term “attention mechanism” refers to a function that includes a mapping between a query and a set of key-value pairs to an output. The output is computed as a weighted sum of the values, where the weight assigned to each value is computed by a compatibility function of the query with the corresponding key. The attention mechanism measures the similarity between the query (Q) and each key-value (K). The similarity returns a weight for each key value, and the mechanism produces an output that is the weighted combination of all the values in a database. Accordingly, from the query (Q) and the keys (K), the mechanism obtains an attention value, which is a weighted sum/linear combination of the values (V), wherein the weights result from some sort of similarity between the query and the keys.

As used throughout the present disclosure, the term “performer network” (or simply “Performer”) refers to a neural network architecture that includes a Fast Attention Via Positive Orthogonal Random Features (FAVOR+) attention mechanism utilized in the model architecture that leverages approaches such as kernel methods and random features approximation for approximating SoftMax and Gaussian kernels. The performer network is a type of variant of the transformer network, that includes a FAVOR+ attention mechanism. One aspect of the performer network includes linearization of input values, thereby enabling the performer network to reduce computational complexity of computing attention from quadratic complexity to linear complexity.

Illustrative embodiments include an HDC-based computation in superposition process that simultaneously passes multiple samples through attention modules in a single pass. Further, illustrative embodiments include superposing multiple keys, values, and queries in unique subspaces. Further, illustrative embodiments include protecting elements (e.g., keys, values, and queries) by projecting said elements into individual subspaces by binding said elements with a unique ID vector. In an embodiment, the ID vector is a randomly generated ID vector.

An illustrative embodiment includes superposing query vectors of separate token sequences into a superposed channel. Accordingly, given a first token sequence and a second token sequence, the illustrative embodiment may superpose the query vectors of each of the first token sequence and the second token sequence for use in computation of attention.

An illustrative embodiment includes superposing key-value pairs of separate token sequences into a superposed channel. Accordingly, given a first token sequence and a second token sequence, the illustrative embodiment may superpose the pairs of key-value vectors of each of the first token sequence and the second token sequence for use in computation of attention.

An illustrative embodiment includes superposing query vectors as well as key-value pair of vectors of separate token sequences into a superposed channel. Accordingly, such embodiment combines superposing query vectors as well as superposing key-value vectors of each of separate token sequences, such as a first token sequence a second token sequence, and computing attention in superposition for the first token sequence and the second token sequence simultaneously.

Illustrative embodiments include a process for performing computations in quasi-orthogonal projected spaces. Illustrative embodiments include identifying non-interfering subspaces such that the non-interfering subspaces enable the performance of operations without interference with one another. Accordingly, illustrative embodiments include performing a single operation on the orthogonal projected space, wherein the single operation is reflected on both non-interfering subspaces simultaneously. The result on one subspace does not interference with the result of another subspace. The output based on the superimposed input is subsequently disentangled to obtain a first output corresponding to the first input subspace and a second output corresponding to the second input subspace.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

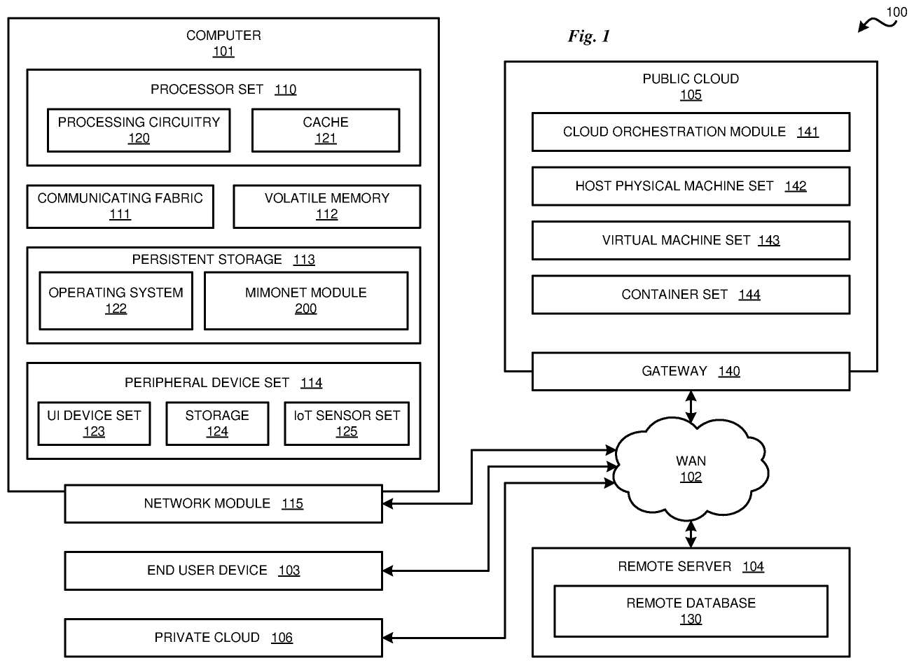

With reference to FIG. 1, this figure depicts a block diagram of a computing environment 100. Computing environment 100 contains an example of an environment for the execution of at least some of the computer code involved in performing the inventive methods, such as a Multiple-Input-Multiple-Output neural network (“MIMONet”) module 200 that simultaneously passes multiple samples through attention modules in a single pass, at least in part by superposing multiple keys, values, and queries into a superposed channel, performing one or more computations on the superposed channel, and disentangling the superposed channel to receive multiple output attention values.

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

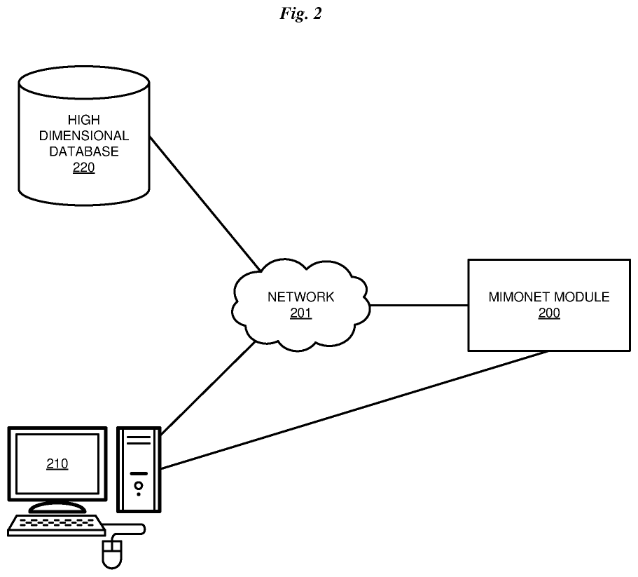

With reference to FIG. 2, this figure depicts an example computing environment in accordance with an illustrative embodiment. In the illustrated embodiment, the MIMONet module 200 includes MIMONet 200 of FIG. 1.

In the illustrated embodiment, a client device 210 is shown deploying MIMONet module 200. Further, in the illustrated embodiment, client device 210 is shown in communication with MIMONet module 200 via network 201. In an embodiment, network 201 includes any suitable network or combination of networks such as the Internet, etc. and may use any suitable communication protocols such as Wi-Fi, Bluetooth, etc., to enable user device 210 to access MIMONet module 200. In some embodiments, MIMONet module 200 is stored on a remote storage device (not shown). In some other embodiments, MIMONet module 200 is stored on a non-transitory computer readable medium of client device 210. Client device 210 may include any suitable computing device, including but not limited to, server, a desktop computer, a laptop, a tablet, a smartphone, an embedded system, etc.

In the illustrated embodiment, a Multiple Input Multiple Output Neural Network (“MIMONet”) module 200 is shown. In an embodiment, the MIMONet module 200 is a software module configured to establish a neural network, bind a pair of data elements to superpose the pair of data elements in a superposed channel, perform computations in superposition on the channel, and unbind the channel to retrieve each of the pair of data elements. In an embodiment, the pair of data elements includes a first sequence of tokens, and a second sequence of tokens. In an embodiment, the first sequence of tokens may include a first series of queries, keys, and values used for computation of attention, while the second sequence of token may include a second series of queries, keys, and values used for computation of attention. In an embodiment, the MIMONet module 200 superposes the first series of queries with the second series of queries. In another embodiment, the MIMONet module 200 superposes a first series of key-value pairs with a second series of key-value pairs. In another embodiment, the MIMONet module 200 superposes the first set of queries with the second set of queries, as well as superposed the first series of key-value pairs and the second series of key-value pairs. Although the depicted scenario described includes a first and as second sequence of data elements, it is contemplated herein that the MIMONet module 200 may be configured to superpose any numbers of separate data elements/sequences of data elements together to perform one or more computations in superposition thereon.

In an embodiment, high-dimensional database 220 stores high dimensional data. In an embodiment, high dimensional data includes text data. In an embodiment, the high dimensional data includes data for the computation of attention. In an embodiment, the high dimensional data also includes binding and/or unbinding keys that may be shared between authorized users for use in encrypting/decrypting private data. In an embodiment, MIMONet module 200 retrieves high dimensional data stored on high dimensional database 220 and performs high-dimensional computing-based techniques, including training and inferencing a neural network, as disclosed in greater detail herein. In the illustrated embodiment, client device 210 enables a person having suitable administrative privileges to modify one or more parameters and/or features associated with MIMONet module 200.

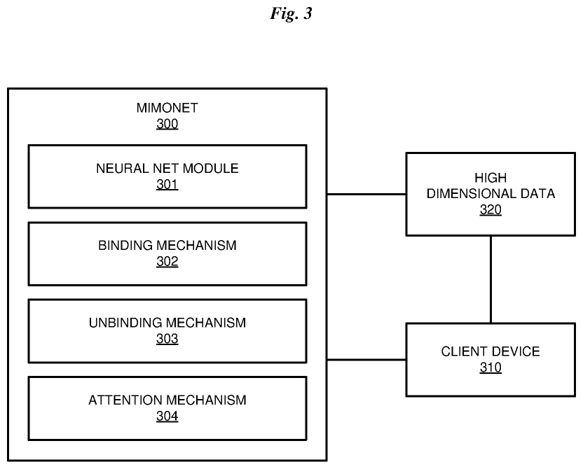

With reference to FIG. 3, this figure depicts a block diagram of an example MIMONet module in accordance with an illustrative embodiment. In the illustrated embodiment, the MIMONet module 300 includes MIMONet module 200 of FIG. 1.

In the illustrated embodiment, MIMONet module 300 is a software module. In the illustrated embodiment, MIMONet module 300 includes a neural network module 301, a binding mechanism module 302, an unbinding mechanism module 303, and a attention mechanism module 304. In alternative embodiments, the MIMONet module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, neural network module 301 is a software module configured to provide a neural network. In an embodiment, neural network module 301 generates a neural network via one or more algorithms. In another embodiment, the neural network module 301 is configured to receive a neural network generated from a remote location. In an embodiment, the neural network module 301 provides a transformer network. In an embodiment, the neural network module 301 provides a performer network. In another embodiment, the neural network module 301 provides a variant and/or modified transformer based or performer-based model architecture.

In the illustrated embodiment, the binding mechanism 302 is a software module configured to bind two data elements or sequences in a subspace, thereby superposing two or more data elements or sequences in a superposed channel. In an embodiment, the binding mechanism 302 is accomplished via a shared binding network. In an embodiment, the binding mechanism 302 generates a vector ID for each data element/sequence, wherein each vector ID corresponds to each element/sequence. In an embodiment, each key, query, and value vector in the attention module of the neural network is bound with a channel-specific ID vector.

In the illustrated embodiment, the unbinding mechanism 303 is a software module configured to unbind the two or more data elements or sequences from a superposed channel. Accordingly, once attention has been computed for a layer of the neural network, the unbinding mechanism 303 unbinds the data elements/sequences to retrieve the attention value for the particular layer. In an embodiment, the formula utilized for binding the first vector and the second vector is the same formula utilized for unbinding the first vector and the second vector.

In the illustrated embodiment, the attention mechanism module 304 is a software module configured to compute attention for one or more layers of the neural network provided by neural network module 301. Suppose the neural network includes a Transformer model, in which case the attention mechanism module 304 may include multiple attention heads, wherein each head focuses on different parts of input data. The heads of the attention mechanism module 304 work in parallel to capture different types of information and patterns in the input. Accordingly, a multi-head attention mechanism module 304 enables the model to attend to different parts of the input sequence simultaneously, enabling the model to capture various types of information in parallel.

Initially, the input data may be linearly projected into multiple subspaces, each associated with a different attention head. This projection enables each attention head to focus on different aspects or patterns within the data. Further, for each attention head, a scaled dot-product attention mechanism is applied independently to the projected data. This mechanism computes attention scores between each token in the input sequence and all other tokens. The attention weights are used to calculate a weighted sum of the value vectors, which results in the output of each attention head for the current token in the sequence.

The model's output is compared to the ground truth for the task (e.g., machine translation output for a given input) using a chosen loss function. The loss quantifies the difference between the model's predictions and the correct answers. During the backward pass, gradients are computed with respect to the model's parameters, including the head-specific query, key, and value weight matrices. These gradients are used to update the weights using gradient descent or a similar optimization algorithm. The training process may be repeated for multiple iterations (epochs), gradually adjusting the query, key, and value weight matrices to minimize the loss and improve the model's performance on the task.

Further, each attention head comprises its own set of learned parameters, including query, key, and value weight matrices. These parameters are trained during the model's training process. As a result, different attention heads can learn to capture different patterns, relationships, or dependencies in the data. The outputs of all attention heads are concatenated and linearly projected again to produce the final multi-head attention output. This combined representation contains information from multiple perspectives, capturing a diverse set of features and relationships in the input data. Head-specific attention weights, including query, key, and value weight matrices, are an essential part of are learned during the training process. The query weight matrix is responsible for transforming the input data into a query vector for each token in the sequence. Accordingly, the query weight matrix determines what aspects of the input each token should focus on when attending to other tokens. The key weight matrix is used to transform the input data into key vectors for each token. These key vectors represent the properties or attributes of each token that other tokens may be interested in. The value weight matrix transforms the input data into value vectors for each token. These value vectors contain information about the content or features of each token, enabling the model to determine importance of the information the model collects from other tokens.

Each attention head in the attention mechanism module 304 includes a set of head-specific query, key, and value weight matrices (Q, K, and V). In an embodiment, the weights are trained through the standard backpropagation and gradient descent optimization process during the training of the model. Initially, the query, key, and value weight matrices for each attention head may be initialized with random values. During the forward pass of the model, input data is linearly transformed using the head-specific Q, K, and V matrices for each attention head. This transformation generates query, key, and value vectors for each token in the sequence. The attention scores are computed for each token using the dot product between query and key vectors to obtain attention weights. These weights determine how much each token should attend to others.

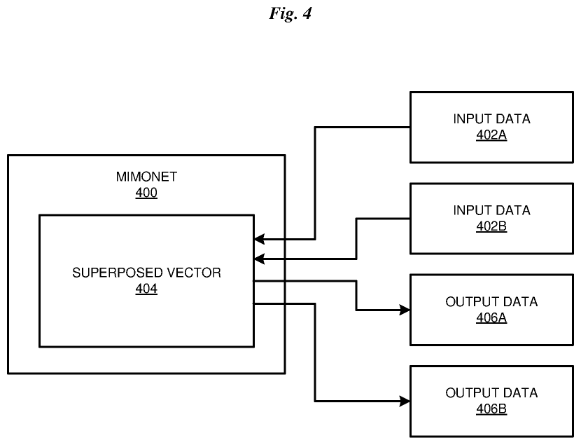

With reference to FIG. 4, this figure depicts a block diagram of an example MIMONet module in accordance with an illustrative embodiment. In the illustrated embodiment, the MIMONet module 400 includes MIMONet module 200 of FIG. 1 and/or MIMONet module 300 of FIG. 3.

In the illustrated embodiment, MIMONet module 400 receives first input data 402a and second input data 402b and produces first output data 404a and second output data 406b. In an embodiment, the first input data 402a and second input data 402b includes high dimensional data. In an embodiment, the first input data 402a includes a first token sequence and the second input data 402b includes a second token sequence. Accordingly, the first token sequences may include a sequence of query vectors, key vectors, and/or value vectors, while the second token sequences may include a different sequence of vectors, key vectors, and/or value vectors.

In the illustrated embodiment, the MIMONet module 400 superposes the first input data 402a and the second input data 402b to create superposed vector 404. Further, the MIMONet module performs a computation in superposition to obtain an attention value for a layer of the neural network. Since the first input data 402a and the second input data 402b are compressed into superposed vector 404, MIMONet module 400 may simultaneously compute attention for 2 separate sequences of tokens. Suppose that input data 402a includes a first sequence of 100 tokens that includes 100 keys and 100 queries, and a second input data 402b includes a second sequence of 100 tokens that includes 100 keys and 100 queries as well. In such a scenario, MIMONet module 400 may superpose the 100 keys of the first sequence and the 100 keys of the second sequence, as well as superpose the 100 queries of the first sequence and the 100 keys of the second sequence, and then compute attention for both sequences simultaneously, rather than compute each sequence separately. In such a manner, the amount of computational resources consumed for computing attention is greatly reduced. Although the depicted scenario describes the token sequences as 100 tokens each, it is contemplated herein that input data 402a and input data 402b may include any number of tokens. Further, the MIMONet module 400 binds each key, query, and/or value vector in the attention module with a specific ID vector, which may be used to unbind superposed vector 404 to retrieve a first output data 406a corresponding to a first input data 402a and a second output data 406b corresponding to the second input data 402b. In the illustrated embodiment, the first output data 406a and the second output data 406b each include a calculated attention value for a layer of the neural network.

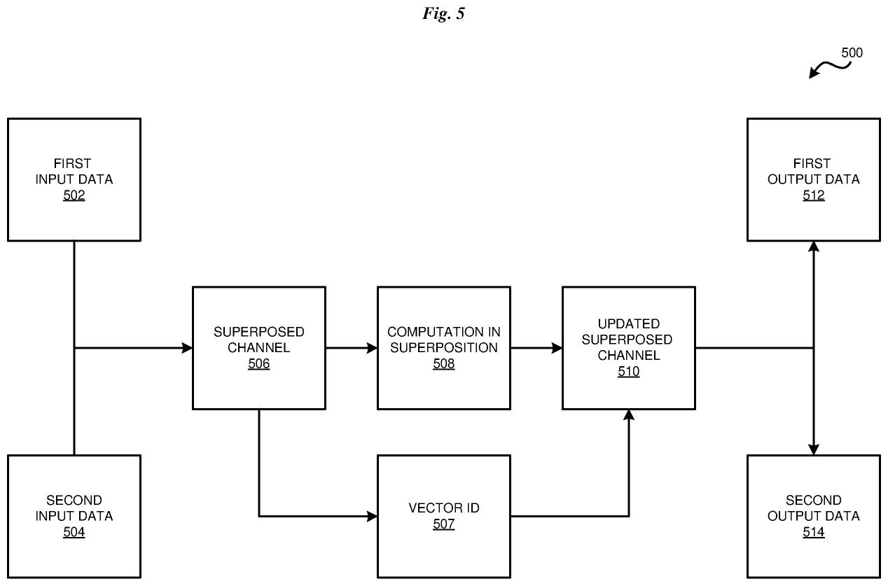

With reference to FIG. 5, this figure depicts a block diagram of an example process for high dimensional computing based neural network training and inferencing in accordance with an illustrative embodiment. In some embodiments, the MIMONet module 200 of FIG. 1, the MIMONet module 300 of FIG. 3, and/or the MIMONet module 400 of FIG. 4 carries aspects of the process 500.

In the illustrated embodiment, a first input data 502 and a second input data 504 undergo a binding operation, thereby projecting the first input data 502 and the second input data 504 into a subspace, i.e., a superposed channel 506. Further, the process 500 generates a vector ID key 507 to unbind the first input data 502 and the second input data 504 from the superposed channel 506. In an embodiment, the key 507 is a randomly generated ID vector. It is contemplated herein that the randomly generated ID vector key 507 ensures the privacy and security of the first input data 502 and the second input data 504 as bundled into superposed channel 506. Once the first input data 502 and the second input data 504 are bundled into a superposed channel 506, the process 500 performs a computation in superposition 508 operation on the superposed channel 506. Accordingly, the compressed representation of input 502 and 504 as superposed channel 506 reduces computational complexity of performing various tasks, such as training and inferencing a neural network model. In an embodiment, the computation in superposition 508 includes calculating multiple attention values for multiple layers of a neural network, as described in greater detail herein. Following the computation in superposition 508, the process 500 transforms superposed channel 508 into an updated superposed channel 510 according to the one or more operations performed. The process 500 subsequently retrieves a first output data 512 corresponding to the first input data 502 and the second output data 514 corresponding to the second input data 504 via each vector ID key 507 generated during binding first input 502 and second input 504 into superposed channel 506.

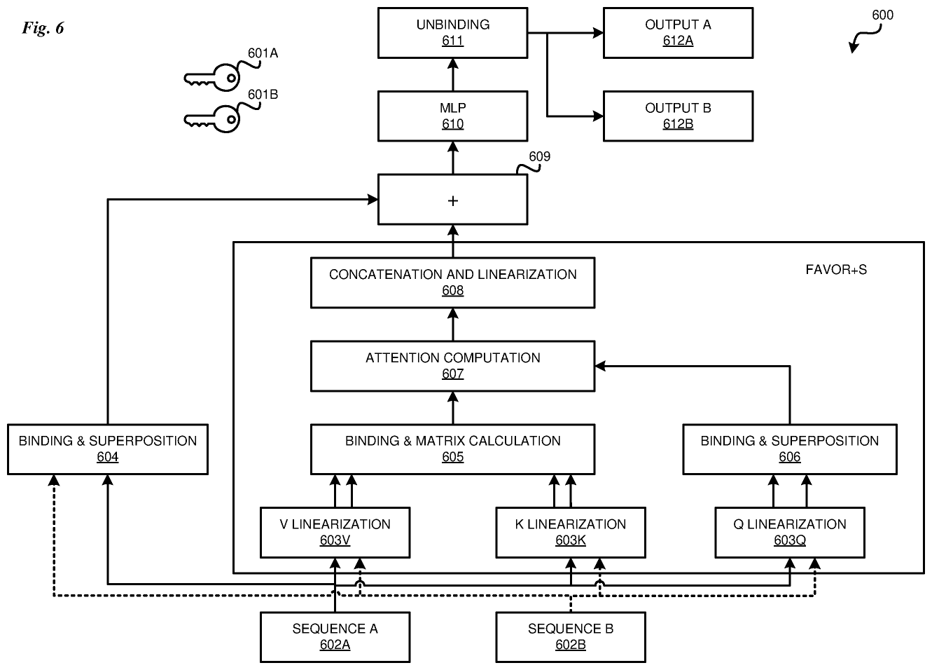

With reference to FIG. 6, this figure depicts a block diagram of a neural network model architecture in accordance with an illustrative embodiment. In an embodiment, the neural network architecture aspects of a transformer network and/or a performer network. In an embodiment, the neural network model 600 combines the linearization function employed by a FAVOR+ mechanism of the performer network with a process of superposing separate tokens token sequences in orthogonal non-interfering subspaces, as described in greater detail herein.

In the illustrated embodiment, the neural network model 600 receives a first sequence 602a and a second sequence 602b as input data into the model 600. Each of first sequence 602a and second sequence 602b may include separate sequences of query vectors, key vectors, and value vectors. In an embodiment, the model 600 linearizes keys as shown by block 603K, values as shown by block 603V, and queries as shown by block 603Q. In an embodiment, the model 600 superposes key-value pairs and performs matrix calculation as shown by block 605. In an embodiment, the model 600 superposes query vectors as shown by block 606. In an embodiment, the model 600 superposes query vectors as shown by block 606.

In the illustrated embodiment, at block 607, the model 600 computes attention based on the query vectors, key vectors, and value vectors of both the first sequence 602a and the second sequence 602b simultaneously, since the first sequence 602a and the second sequence 602b have been projected and bundled into a superposed channel. In the illustrated embodiment, block 608 represents concatenation and linearization for the attention calculated at block 607. In the illustrated embodiment, block 604 represents a skip-connection, whereby certain computations are not performed by the model in the computation of attention.

Further, the first sequence 602a is associated with a first channel specific ID vector 601a and the sequence is associated with a second channel specific ID vector 601b. Block 609 represents an unbinding mechanism that utilizes a first channel specific ID vector 601a and the second channel specific ID vector 602b to unbind and detangle the first sequence 602a and the second sequence 602b from each other, respectively. The process may be repeated for each layer of a multi-layer perception, as represented by block 610. Accordingly, unbinding may be performed after the computation of attention of each layer, prior to computation of attention for the next layer. Transformed vector output A 612a corresponding to sequence A 602a may be retrieved via first channel specific ID vector 601a, and transformed vector output B 612b corresponding to sequence B 602b may be retrieved via first channel specific ID vector 601b.

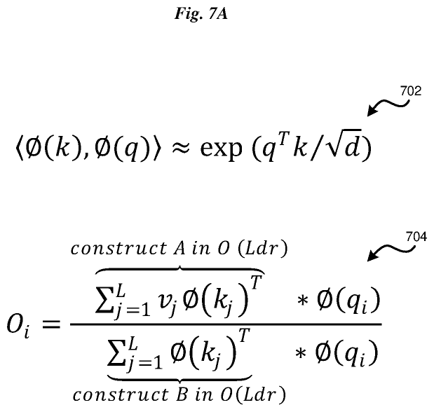

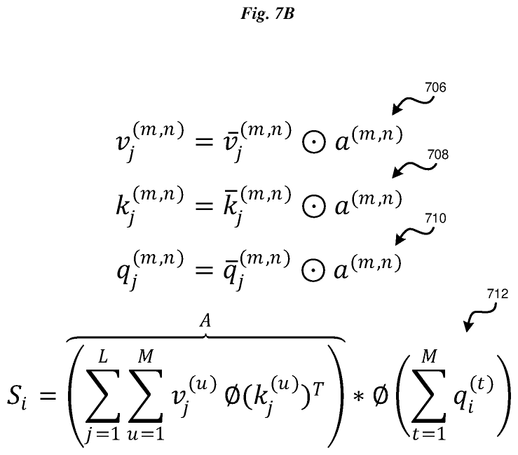

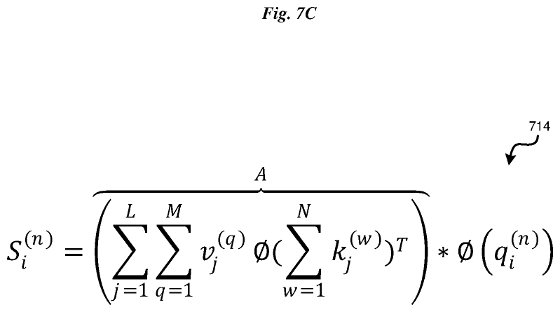

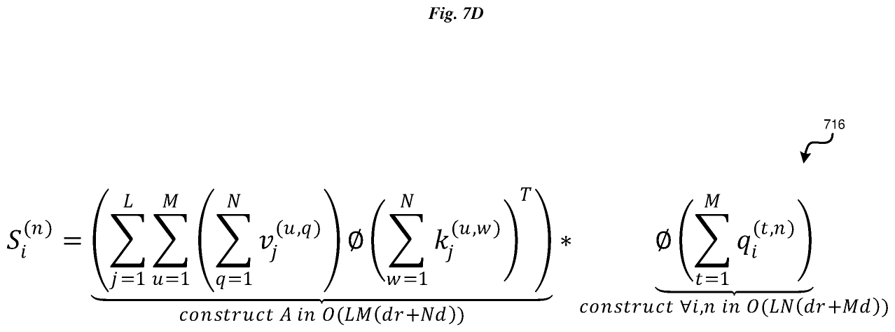

With reference to FIGS. 7A-7D, these figures depict example formulae related to aspects of a process for high dimensional computing based neural network training and inferencing in accordance with an illustrative embodiment. An example embodiment of the disclosed process may generally include the following steps. First, a binding operation is applied to two or more sets of vectors (values, keys, and/or queries). Next, the two or more sets of vectors are superposed and thereby projected into a superposed channel. Next, attention is computed via the vectors in superposition. Once attention is computed, an unbinding operation may be applied to retrieve individual output vectors representing attention for a given layer. Accordingly, in an embodiment, each output is inferred by applying an unbinding operation on the transformed superposed embedding. It is contemplated that the matrix-vector multiplication may be accelerated by computing attention in a single pass for multiple query vectors in superposition. It is further contemplated that the computation of the value-key outer product may be accelerated by first superposing bound values and keys, which are dynamic activations of previous layers. In some embodiments, vectors for computing attention may be projected into a superposed channel without first being bound via a binding operation.

With reference to FIG. 7A, this figure depicts an example formula for linearization of attention computation. It is contemplated that since the exponential value of the key-value inner product is a kernel, it may be represented as an explicit inner product via an inverse kernel operation in an infinite dimensional space of transformed inputs. Accordingly, the mapping to this infinite-dimensional space may be approximated with a randomized feature map Φ(.), as shown by formula 702. Further, in an embodiment, attention may be defined by formula 704, where first matrices A and B may be computed, followed by a computation of matrix product with the vector, which may yield a linear complexity in the sequence of length L.

With reference to FIG. 7B, this figure depicts example formulae related to projecting multiple queries into a superposition. In an embodiment, the process binds vectors with a channel specific ID vector, and the process superposes the bounded vectors causing the bounded vectors to be projected into a superposed channel space. Accordingly, in some such embodiments, the process may compute attention for multiple queries (e.g., a batch of queries of different sequences) in superposition. In an embodiment, unbinding may be accomplished via the same vector ID for each channel. Accordingly, in an embodiment, the unbinding operation includes an inverse of the binding operation.

In the illustrated embodiment, formulas 706, 708, and 710, depict formulas that define binding vectors with a channel specific ID vector to cause each key, query, and value vector of the attention mechanism to be bound with a channel specific ID vector. Accordingly, formulas 706, 708, and 710 define binding operations for vectors involved in the computation of attention. In the illustrated embodiment, formula 706 represents binding a value vector with a channel specific vector a. As shown in the formula 706, v̅ represents and original value vector whereas v represents the bound version of the value vector. In the illustrated embodiment, formula 708 represents binding a key vector with a channel specific vector a. As shown in the formula 708, k̅ represents and original key vector whereas k represents the bound version of the key vector. In the illustrated embodiment, formula 710 represents binding a query vector with a channel specific vector a. As shown in the formula 710, q̅ represents and original query vector whereas q represents the bound version of the query vector.

Each of formulas 706, 708, and 710 represent binding values vectors, key vectors, and query vectors, respectively, in a new subspace from the original vector space via a channel specific vector. Suppose, as a nonlimiting example, that four channels (M) exist, in which case each of the four channels (M) may be bound with a channel specific ID vector. In such a scenario, each of the four bounded channels do not overlap with each other, and do not overlap with the original subspaces in which the vectors originally existed. Further, superposing the channels causes the channels to be projected in a superposed channel that does not overlap, and thus does not interfere, with any of the bounded channel subspaces, nor with any of the original vector spaces. Accordingly, in such a manner, there is no interference between any of the vectors stored in any of the subspaces mentioned. Further, as shown in formulas 706, 708, and 710, the tuple (m,n) represents a specific channel. In an embodiment, the tuple (m,n) indicates an index corresponding to a specific channel. For example, suppose four channels exist, the first channel may be represented as (0,0), the second channel may represented as (0,1), the second channel may represented as (1,0), and the fourth channel may represented as (1,1). In some embodiments, the channel includes only a single dimension (m).

In the illustrated embodiment, formula 712 depicts multiple sequences of queries bounded into M channels. After constructing M channels, the process generates the superposition in the construction of A and in the queries. The output Sᵢ represents the superposition of bound output values. The individual output vectors may be retrieved as Oᵢ=Sᵢ ⊙a^{(m)}. Suppose, as a nonlimiting example, that two sets of query vectors exist, in which case the two sets of query vectors may be bounded, and then subsequently bundled in a superposition and summed. After summation, the inverse-kernel operation may be performed on the summed queries. Accordingly, the example operation accelerates matrix vector multiplication by M times.

With reference to FIG. 7C, this figure depicts an example formula related to building value-key tensor products in superposition. In the illustrated embodiment, formula 714 defines computation of value-key tensor products in superposition. As shown in formula 714, the computation of A in superposition may be accomplished by computing the value or N keys and N values. The resulting computation includes the output of the n-th channel (combined with noise). Accordingly, the example operation accelerates the computation of the A matrix by a factor of N.

With reference to FIG. 7D, this figure depicts example formulas related to simultaneously projecting both query products and value-key tensor products into a superposition. In an embodiment, query products and value-key tensor products are encoded in a superposition channel in a 2-dimensional (2D) grid. In the illustrated embodiment, the formulas depicted by FIG. 7B and FIG. 7C are combined in formula 716 depicted by FIG. 7D. Accordingly, formula 716 depicts an example embodiment of the process that includes encoding superposition channels in a two-dimensional grid of size (N)*(M). In the illustrated embodiment, the output of a specific channel (m,n) may be computed via the application of the following unbinding operation: Oᵢ(^{m,n})=Sᵢ⁽ⁿ⁾⊙a^{(m,n)}. In an embodiment, suppose that M=N, in which case the process achieves a speedup of \sqrt{N²} (or simply N).

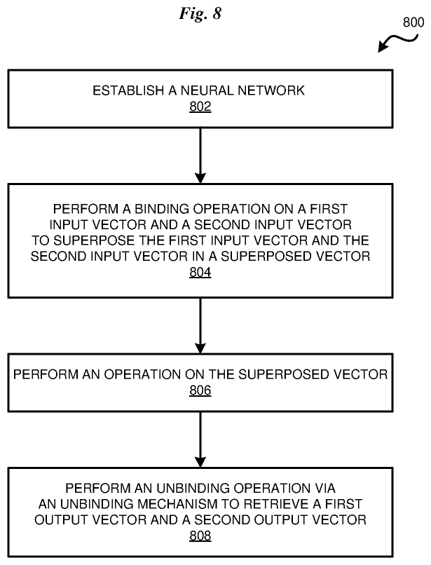

With reference to FIG. 8, this figure depicts an example flowchart illustrating a process for high dimensional computing based neural network training and inferencing in accordance with an illustrative embodiment. In some embodiments, the MIMONet module 200 of FIG. 1, the MIMONet module 300 of FIG. 3, and/or the MIMONet module 400 of FIG. 4 carries out the process 800.

At step 802, the process establishes a neural network. In some embodiments, the neural network includes aspects of a transformer network and/or a performer network. Accordingly, the transformer network may include a multi-head attention mechanism configured for computing attention based on query vectors, key vectors, and value vectors.

At step 804, the process performs a binding operation on a first input vector and a second input vector to superpose the first input vector and the second input vector into a superposed vector. In an embodiment, the first vector includes a first query vector, and the second vector includes a second query vector. In another embodiment, the first vector includes a first key-value vector and the second vector includes a second key-value vector. In some embodiments, the process includes superimposing both query vectors, as well as key-value vectors.

At step 806, the process performs an operation on the superposed vector. In an embodiment, the process includes computing attention based on a combination of query vectors and key value vectors. Accordingly, since the first input vector and the second input vector have been superposed in a superposed vector, the process performs an operation on both the first vector and the second vector simultaneously.

At step 808, the process performs an unbinding operation via an unbinding mechanism to retrieve the first vector and the second vector. In an embodiment, the unbinding includes utilization of a vector ID that the process has generated during the binding of the first vector and the second vector. In an embodiment, process performs the binding and unbinding operations for each layer of the neural network.

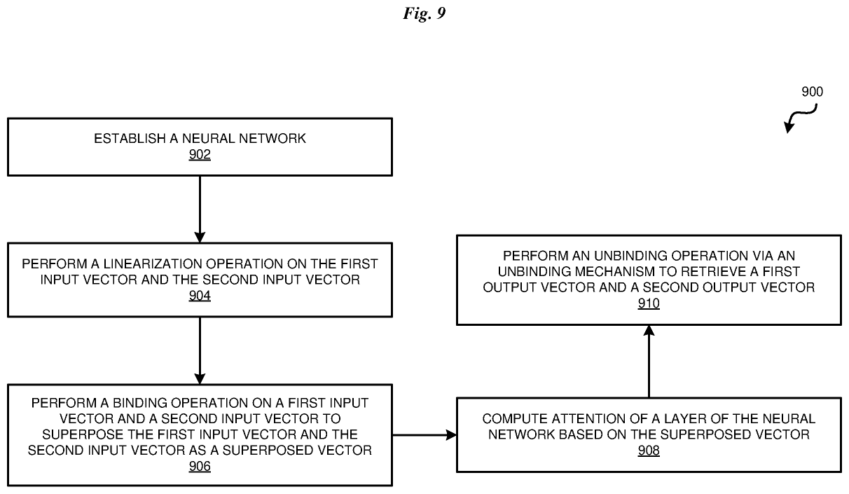

With reference to FIG. 9, this figure depicts an flowchart illustrating an example process for high dimensional computing based neural network training and inferencing in accordance with an illustrative embodiment. In some embodiments, the MIMONet module 200 of FIG. 1, the MIMONet module 300 of FIG. 3, and/or the MIMONet module 400 of FIG. 4 carries out the process 900.

At step 902, the process establishes a neural network. In some embodiments, the neural network includes aspects of a transformer network and/or a performer network. Accordingly, the transformer network may include a multi-head attention mechanism configured for computing attention based on query vectors, key vectors, and value vectors.

At step 904, the process performs a linearization operation on a first input vector and a second input vector. In an embodiment, the first input vector includes a first sequence of tokens and the second input vector includes a second sequence of tokens. In an embodiment, the process performs an inverse-kernel operation to linearize the first input vector and the second input vector. In an embodiment, the process may create a mapping between all queries and all keys in a given sequence of tokens. The mapping to the infinite-dimensional space may be approximated with a randomized feature map. The linearization operation may be performed by computing the dot product between keys and queries of the feature map constructed via the inverse-kernel operation previously performed. Accordingly, the linearization function reduces the computational complexity of computing attention from quadratic complexity to linear complexity.

At step 906, the process performs a binding operation on the first input vector and a second input vector to superpose the first input vector and the second input vector into a superposed vector. In an embodiment, the first vector includes a first query vector, and the second vector includes a second query vector. In another embodiment, the first vector includes a first key-value vector and the second vector includes a second key-value vector. In some embodiments, the process includes superimposing both query vectors, as well as key-value vectors.

At step 908, the process computes the attention of a layer of the neural network based on the values contained within the superposed vector. In an embodiment, the process performs matrix-vector multiplication to compute the attention in a single pass for multiple queries in the superposition.

At step 910, the process computes performs an unbinding operation via an unbinding mechanism to retrieve a first output vector corresponding to the first input vector and a second output vector corresponding to the second input vector. Accordingly, the process infers each output by applying an unbinding on the superposed embedding. It is contemplated that the steps of the process may be performed for each layer of a neural network. The steps of the process as described herein enable simultaneous processing of multiple attention-based tokens with similar number of parameters.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing a neural network, wherein the neural network comprises a plurality of layers;
receiving a plurality of input data sequences into a layer of the neural network, the plurality of input data sequences comprising a first input data sequence and a second input data sequence;
superposing the first input data sequence and the second input data sequence, thereby creating a superposed embedding;
transforming the superposed embedding by applying a function to the superposed embedding, thereby creating a transformed superposed embedding; and
inferring a first output data element corresponding to the first input data sequence and a second output data element corresponding to the second input data sequence,
wherein the inferring the first output data element and the second output data element comprises applying a shared unbinding operation on the transformed superposed embedding.

2. The computer-implemented method of claim 1, further comprising applying a linearization function to the first input data sequence and the second input data sequence.

3. The computer-implemented method of claim 1, wherein the first input data sequence comprises a first query vector embedding and the second data sequence comprises a second query vector embedding.

4. The computer-implemented method of claim 1, wherein the first input data sequence comprises a first key-value vector embedding and the data sequence comprises a second key-value vector embedding.

5. The computer-implemented method of claim 1, further comprising generating a first vector identification key corresponding to the first input data sequence and generating a second vector identification key corresponding to the second input data sequence.

6. The computer-implemented method of claim 5, wherein the inferring the first output data element and the second output data element comprises applying the first vector identification key to infer the first output data element and applying the second vector identification key to infer the second output data element.

7. The computer-implemented method of claim 1, wherein the neural network comprises a linear-attention transformer network.

8. The computer-implemented method of claim 1, wherein the neural network comprises a performer network.

9. The computer-implemented method of claim 1, wherein the method is repeated for each layer of the neural network.

10. A computer program product comprising one or more computer readable storage media, and program instructions collectively stored on the one or more computer readable storage media, the program instructions executable by a processor to cause the processor to perform operations comprising: establishing a neural network, wherein the neural network comprises a plurality of layers;
receiving a plurality of input data sequences into a layer of the neural network, the plurality of input data sequences comprising a first input data sequence and a second input data sequence;
superposing the first input data sequence and the second input data sequence, thereby creating a superposed embedding;
transforming the superposed embedding by applying a function to the superposed embedding, thereby creating a transformed superposed embedding; and
inferring a first output data element corresponding to the first input data sequence and a second output data element corresponding to the second input data sequence,
wherein the inferring the first output data element and the second output data element comprises applying an unbinding operation on the transformed superposed embedding.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, further comprising applying a linearization function to the first input data sequence and the second input data sequence.

14. The computer program product claim 10, wherein the first input data sequence comprises a first query vector embedding and the second input data sequence comprises a second query vector embedding.

15. The computer program product claim 14, wherein the first input data sequence comprises a first key-value vector embedding and the second query vector comprises a second key-value vector embedding.

16. The computer program product claim 15, further comprising generating a first vector identification key corresponding to the first input data sequence and generating a second vector identification key corresponding to the second input data sequence, and wherein the inferring the first output data element and the second output data element comprises applying the first vector identification key to infer the first output data element and applying the second vector identification key to infer the second output data element.

17. A computer system comprising a processor and one or more computer readable storage media, and program instructions collectively stored on the one or more computer readable storage media, the program instructions executable by the processor to cause the processor to perform operations comprising:
establishing a neural network, wherein the neural network comprises a plurality of layers;
receiving a plurality of input data sequences into a layer of the neural network, the plurality of input data sequences comprising a first input data sequence and a second input data sequence;
superposing the first input data sequence and the second input data sequence, thereby creating a superposed embedding;
transforming the superposed embedding by applying a function to the superposed embedding, thereby creating a transformed superposed embedding; and
inferring a first output data element corresponding to the first input data sequence and a second output data element corresponding to the second input data sequence,
wherein the inferring the first output data element and the second output data element comprises applying an unbinding operation on the transformed superposed embedding.

18. The computer system of claim 17, further comprising applying a linearization function to the first input data sequence and the second input data sequence.

19. The computer system of claim 17, wherein the first input data sequence comprises a first query vector embedding and a first key-value vector embedding, and wherein the second input data sequence comprises a second query vector embedding and a second key-value vector embedding.

20. The computer system of claim 19, further comprising generating a first vector identification key corresponding to the first input data sequence and generating a second vector identification key corresponding to the second input data sequence, and wherein the inferring the first output data element and the second output data element comprises applying the first vector identification key to infer the first output data element and applying the second vector identification key to infer the second output data element.
